(19) United States
(12) Patent Application Publication
(10) Pub. No.: US 2009/0233719 A1
(43) Pub. Date: Sep. 17, 2009

(54) SECONDARY GAME SYSTEM, A GAMING SYSTEM AND A METHOD OF PROVIDING AT LEAST ONE SECONDARY GAME IN A GAMING SYSTEM

(75) Inventors: Dean Wright, New South Wales (AU); Stephen Cowan, New South Wales (AU)

Correspondence Address: Pearne & Gordon LLP, 1801 East 9th Street, Suite 1200, Cleveland, OH, 44114-3108, US

(73) Assignee: PALTRONICS AUSTRALASIA PTY LIMITED, TAREN POINT, NSW 2229 (AU)

(21) Appl. No.: 12/513,956

(22) PCT Filed: Oct. 31, 2007
(86) PCT No.: PCT/AU2007/001659

§ 371 Date: Jun. 3, 2009

(30) Foreign Application Priority Data
Nov. 8, 2006 (AU) 2006906239

(51) Int. Cl. A63F 9/24; A63F 13/00

(52) U.S. Cl. 463/42

(57) ABSTRACT

A secondary game system for a gaming terminal network, including at least one secondary game controller for providing at least one secondary game; a communications device for receiving secondary game registration request messages and secondary game deregistration request messages from a gaming terminal; the system being responsive to a received secondary game registration request message from a gaming terminal by causing said gaming terminal to be registered in one of said at least one secondary game; the system being further responsive to a received secondary game deregistration request message from a gaming terminal by causing said gaming terminal to be deregistered from one of said at least one secondary game.

The present invention relates to a secondary game system, a gaming system and a method of providing at least one secondary game in a gaming system.

The invention has been developed primarily for use with a plurality of interlinked gaming machines in a gaming establishment and will be described with reference to this application. However, the invention is not limited to that particular field of use and is also suitable for use with online gaming, gaming machines that are distributed over a plurality of gaming establishments, lotto, pools, lotteries, art unions, bingo, raffles and other games involving one or more wagers being placed upon an outcome having a finite probability of occurring.

### BACKGROUND

The discussion of the prior art within this specification is to assist the addressee to understand the invention and is not an admission of the extent of the common general knowledge in the field of the invention and is included without prejudice.

It is known to link gaming machines to provide a number of additional functionalities. This includes the ability to control the awarding of a prize, as the pool of available finds is greater and the amount of funds available is known rather than having to be estimated. Another known purpose of interlinking gaming machines is to provide secondary gaming such as a linked jackpot. In such a system, a central display typically provides the players with a visual indication of a presently available jackpot prize which is increased incrementally as the players operate the interlinked gaming machines. It is known by the players that the prize will be awarded when it reaches a secret, randomly selected value that is less than a predetermined limit value. The limit value is often also visually indicated to the players by means of the display.

The use of such functionality is intended to attract players to play the machines in the hope of winning the jackpot. However, with the increased sophistication of players and their increased exposure to such systems, the systems' ability to maintain players' interest has diminished.

It is an object of the present invention to overcome, or at least substantially ameliorate, one or more of the disadvantages of the prior art or at least to provide a useful alternative.

### SUMMARY OF THE INVENTION

A first aspect of the invention provides a secondary game system for a gaming terminal network, including:

at least one secondary game controller for providing at least one secondary game; and

a communications device for receiving secondary game registration request messages and secondary game deregistration request messages from a gaming terminal;

the system being responsive to a received secondary game registration request message from a gaming terminal by causing said gaming terminal to be registered in one of said at least one secondary game; and

the system being further responsive to a received secondary game deregistration request message from a gaming terminal by causing said gaming terminal to be deregistered from one of said at least one secondary game.

The secondary game system preferably includes a plurality of secondary game controllers for providing respective secondary games.

The secondary game system is preferably responsive to a received secondary game registration request message from a gaming terminal by causing said gaming terminal to be registered in one of said secondary games selected in dependence upon data extracted from said secondary game registration request message.

Additionally or alternatively, the secondary game system is preferably responsive to a received secondary game deregistration request message from a gaming terminal by causing said gaming terminal to be deregistered from one of said secondary games determined in dependence upon data extracted from said secondary game deregistration request message.

Preferably, the secondary game controllers include respective secondary game controller communications devices for receiving messages from respective pluralities of gaming terminals.

Each of the secondary game controllers is preferably adapted upon receipt of a secondary game registration request message or a secondary game deregistration request message to communicate with another of the secondary game controllers in dependence upon data extracted from said secondary game registration request message or secondary game deregistration request message.

The secondary game controller communications devices are preferably adapted to receive secondary game contribution messages, and wherein the secondary game controllers are adapted upon receipt of a secondary game contribution message to communicate with another of the secondary game controllers.

The secondary game system preferably further includes a secondary game coordinator in communication with said plurality of secondary game controllers, and adapted to maintain a database including for each of a plurality of gaming terminals data indicative of respective secondary games in which the gaming terminal is registered.

A second aspect of the invention provides a gaming system including a gaming terminal and a secondary game system as set out above.

The gaming terminal preferably includes a user-operable registration input device for allowing a user of the gaming terminal to indicate a desire to register in a secondary game, and wherein the gaming terminal is responsive to operation of the user-operable registration input device by sending a secondary game registration request message to the secondary game system.

Additionally or alternatively, the gaming terminal preferably includes a user-operable deregistration input device for allowing a user of the gaming terminal to indicate a desire to deregister from a secondary game, and wherein the gaming terminal is responsive to operation of the user-operable deregistration input device by sending a secondary game deregistration request message to the secondary game system.

The gaming terminal preferably includes a user-operable secondary game contribution input device for allowing a user of the gaming terminal to specify a desired contribution to a secondary game.

A further aspect of the invention provides a method of providing at least one secondary game in a gaming terminal network, including:

receiving secondary game registration request messages and secondary game deregistration request messages from a gaming terminal;

responding to a received secondary game registration request message from a gaming terminal by causing said gaming terminal to be registered in one of said at least one secondary game; and

responding to a received secondary game deregistration request message from a gaming terminal by causing said gaming terminal to be deregistered from one of said at least one secondary game.

A plurality of secondary games are preferably provided.

Preferably, the step of responding to a received secondary game registration request message from a gaming terminal includes the steps of:

extracting data from said secondary game registration request message; and

causing said gaming terminal to be registered in one of said secondary games selected in dependence upon said extracted data.

The step of responding to a received secondary game deregistration request message from a gaming terminal preferably includes the steps of:

extracting data from said secondary game deregistration request message; and

causing said gaming terminal to be deregistered from one of said secondary games determined in dependence upon said extracted data.

The method preferably includes the step of:

maintaining a database including for each of a plurality of gaming terminals data indicative of respective secondary games in which the gaming terminal is registered.

Other aspects of the invention provide a computer program for causing a computer to execute a method as set out above, a data carrier carrying data embodying such a computer program and a signal carrying data embodying such a computer program.

### BRIEF DESCRIPTION OF THE DRAWINGS

Preferred embodiments of the invention will now be described, by way of example only, with reference to the accompanying drawings, in which:

FIG. 1 is a schematic block diagram of a gaming system including a secondary game system;

FIG. 2 is a schematic block diagram of a preferred embodiment of a gaming system;

FIG. 3 is a more detailed schematic block diagram of a gaming terminal of the gaming system shown in FIG. 2;

FIG. 4 is a more detailed schematic block diagram of a secondary game controller of the gaming system shown in FIG. 2; and

FIG. 5 is a schematic block diagram of another embodiment of a gaming system.

### DETAILED DESCRIPTION

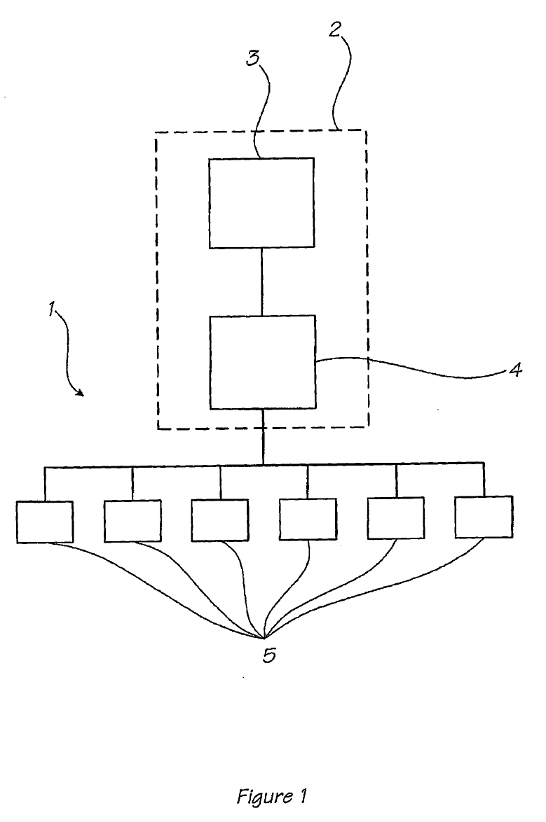

In overview, FIG. 1 is a schematic block diagram of a gaming system 1 including a secondary game system 2 for a gaming terminal network. The secondary game system includes at least one secondary game controller 3 for providing at least one secondary game, and a communications device 4 for receiving secondary game registration request messages and secondary game deregistration request messages from a gaming terminal 5. The secondary game system 2 is responsive to a received secondary game registration request message from a gaming terminal 5 by causing said gaming terminal to be registered in one of said at least one secondary game. The secondary game system 2 is further responsive to a received secondary game deregistration request message from a gaming terminal 5 by causing said gaming terminal to be deregistered from one of said at least one secondary game.

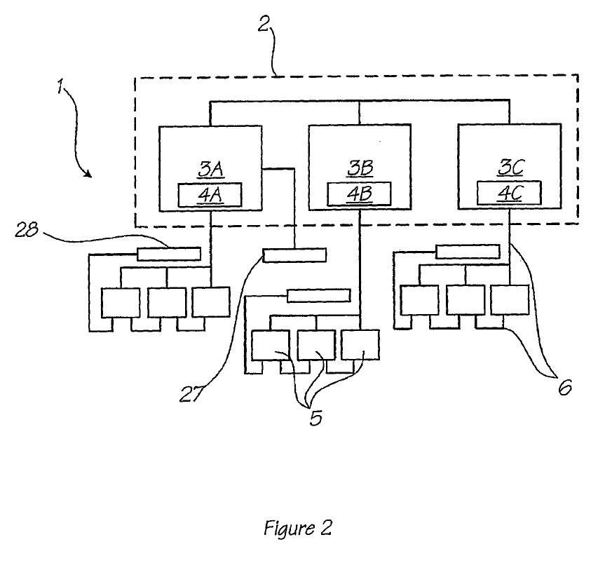

FIG. 2 shows a preferred structure of a gaming system 1. This gaming system includes a secondary game system 2, which in turn includes three secondary game controllers or jackpot controllers 3A, 3B, 3C for providing respective secondary games in the form of jackpot games. In this specification, “jackpot game” is intended to mean a single- or multi-level jackpot game in which a player participates by playing a primary game on a gaming terminal, a proportion of the wager made on or the turnover of or the funds added to the gaming terminal being used as a contribution in the jackpot game.

Each of the secondary game controllers provides a particular respective secondary game or jackpot game, and each includes a respective communications device 4A, 4B, 4C for communicating with a respective cluster of gaming terminals 5 via a serial, non-addressable, multi-drop communications link, such as an RS-485 link 6. In one embodiment, by default, each of the gaming terminals 5 connected to a particular secondary game controller 3A, 3B, 3C is registered in the secondary game provided by that controller (the “local” secondary game). In another embodiment, the gaming system is initialised such that each of the gaming terminals is registered in a secondary game selected by venue management.

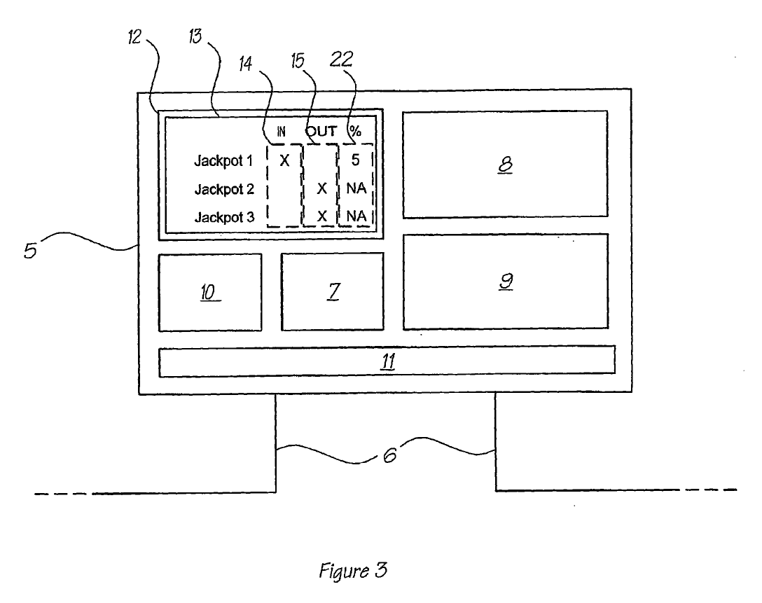

With reference to FIG. 3, each gaming terminal 5 includes a processor 7 for providing a primary game. A display screen 8 provides a user with information regarding the primary game, and a control panel 9 allows the user to make selections and input information relating to the primary game. Memory 10 is also provided. A communications card 11 allows communication with the secondary game system 2. A secondary game control panel 12 is also provided having a touch screen 13 for displaying information regarding available secondary games and for allowing the user of the gaming terminal to make selections. A first region 14 of the touch screen 13 serves as a user-operable registration input device, in that the user of the gaming terminal may operate that region 14 to indicate a desire to register in a secondary game. Similarly, a second region 15 of the touch screen 13 serves as a user-operable deregistration input device, in that the user may operate that region 15 to indicate a desire to deregister from a secondary game.

The gaming terminal is responsive to operation of the first region 14 of the touch to screen by sending a secondary game registration request message to the secondary game system 2. The secondary game registration request message includes information identifying: the gaming terminal sending the message; and the secondary game to which registration is desired. Similarly, the gaming terminal is responsive to operation of the second region 15 of the touch screen by sending a secondary game deregistration request message to the secondary game system 2. The secondary game deregistration request message includes information identifying: the gaming terminal sending the message; and the secondary game from which deregistration is desired.

In one embodiment, a gaming terminal may only be registered in one secondary game at any time. In this embodiment, when the first region 14 of the touch screen 13 is operated, the gaming terminal 5 sends both a secondary game registration request message to effect registration in the newly selected secondary game, and a secondary game deregistration request message to effect deregistration from the previous secondary game. In an alternative such embodiment, a single message is sent which effects both transactions. In other embodiments, registration in zero or multiple secondary games is permitted; in such embodiments, it is not necessary to effect both types of transaction at each operation of the first and second regions 14, 15 of the touch screen 13.

In one embodiment, the gaming terminal sends secondary game contribution messages in a known way to the secondary game controller 3A, 3B, 3C. In other embodiments, for example in which registration in more than one secondary game is permitted, more sophisticated secondary game contribution messages are required which include both information to identify the value of the contribution, and addressing information of the controller 3A, 3B, 3C providing the secondary game to which the contribution is to be made.

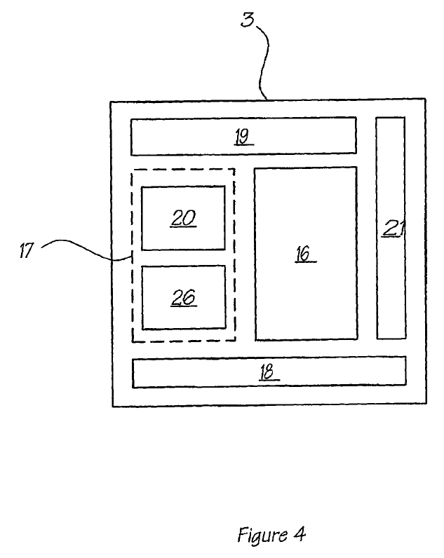

FIG. 4 is a block diagram of a secondary game controller 3 forming part of the secondary game system 2. The secondary game controller 3 includes a processor 16, for providing a secondary game, and associated memory 17. The controller 3 also includes a communications device 18, in the form of an RS-485 card, for communications with gaming terminals 5. A second communications device 19, in the form of an interface card for an addressable communications network such as an Ethernet, provides for communication between secondary game controllers 3 in the secondary game system 2. In the memory 17, the controller 3 stores information 20 regarding the associated gaming terminals 5. That is to say, for each gaming terminal 5 connected to the controller via the RS-485 link, the memory includes information regarding the secondary game or games in which each associated gaming terminal is registered. The secondary game controller also includes a video card 21 for controlling a display screen 22 for displaying to users of gaming terminals 5 information regarding the secondary game being provided by the secondary game controller.

Upon receipt of a secondary game registration request message from a gaming terminal 5, a secondary game controller 3A extracts from the message the information identifying the gaming terminal and the desired secondary game. If the desired secondary game is the local secondary game, the secondary game controller 3A updates the stored information to indicate that the gaming terminal is registered in that secondary game. If the desired secondary game is a secondary game provided by another secondary game controller 3B, 3C (a “remote” secondary game), the secondary game controller receiving the message updates the stored information to indicate the controller 3B, 3C to which secondary game contribution messages from that gaming terminal 5 are to be passed. The secondary game controller 3A also sends a secondary game registration control message to the secondary game controller 3B, 3C providing the desired secondary game. That secondary game controller 3B, 3C updates information stored in its memory to indicate that a remote gaming terminal is registered.

In an analogous way, upon receipt of a secondary game deregistration message from a gaming terminal 5, the secondary game controller 3A extracts from the message the information identifying the gaming terminal and the secondary game from which deregistration is desired. Locally stored information about the gaming terminal 5 is updated and a message sent to a further secondary game controller 3B, 3C, if the identified secondary game is remote.

As indicated above, the gaming terminals 5 send secondary game contribution messages. The secondary game controllers 3A, 3B, 3C extract from these messages information identifying the gaming terminal 5 from which they were sent. By accessing the locally stored information 20, a controller 3A receiving such a message is able to determine whether the contribution is to be applied to the local secondary game, or if the message must be forwarded to another of the secondary game controllers 3B, 3C.

In a preferred embodiment, the gaming terminals 5 include respective user-operable secondary game contribution input devices, in the form of a third region 22 of the touch screen 13, for allowing a user of the gaming terminal to specify a desired contribution to a secondary game. A similar system is discussed in our copending PCT patent application published with the number WO 2005/107913 A1, the full contents of which are herein incorporated by reference. In this way, the user may reduce or increase the amount of his contribution to a secondary game, and thereby reduce or increase the likelihood of winning the secondary game, while simultaneously increasing or reducing his wager on the primary game.

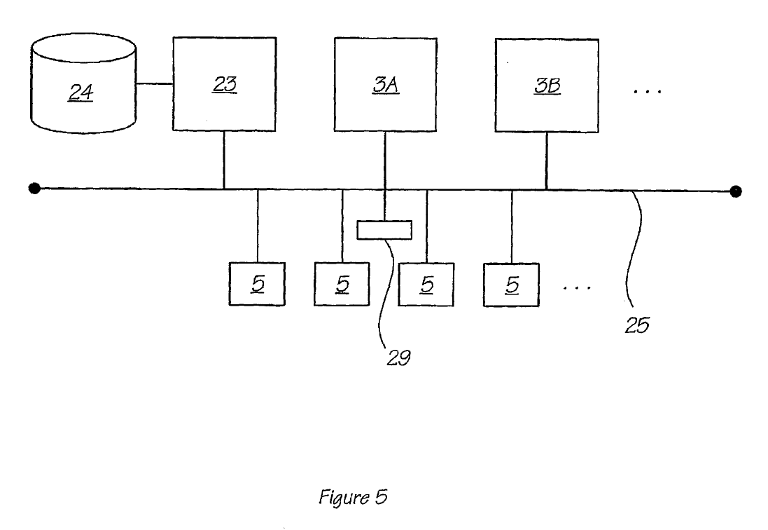

In the foregoing example, data indicating which gaming terminal 5 is registered in which of the secondary games is stored and processed by the secondary game controllers 3A, 3B, 3C themselves. In a further embodiment, shown schematically in FIG. 5, a secondary game coordinator 23 is provided in communication with the secondary game controllers. In this embodiment, the secondary game coordinator 23 maintains a database 24 including for each of a plurality of gaming terminals data indicative of respective secondary games in which the gaming terminal is registered. The gaming terminals, the secondary game controllers and the secondary game coordinator communicate via an Ethernet link 25, and the secondary game coordinator ensures that secondary game contribution messages are routed to the appropriate secondary game controller 3A, 3B, 3C.

In the previously described embodiment of a gaming system, shown in FIG. 2, the routing of messages from the gaming terminals to the appropriate secondary game controller is managed by the secondary game controllers. In the present embodiment, shown in FIG. 5, using an Ethernet or another addressable networking system, the gaming terminals themselves, or the respective communication cards 11 in the gaming terminals, may include addressing information in the various messages that they send. Alternatively, all messages sent by the gaming terminals may be received by the secondary game coordinator, which responds by issuing appropriately addressed messages to the appropriate secondary game controllers.

In a preferred embodiment, at least one of the secondary games (a “restricted” secondary game) is only available to users of gaming terminals 5 that are providing a specified primary game. In such an embodiment, the secondary game system stores resource data 26, for example in the memory of the secondary game controllers 3A, 3B, 3C. This resource data includes executable files and audiovisual data for allowing the gaming terminals to provide a particular primary game. In the event that a user indicates a desire to participate in a restricted secondary game, and his gaming terminal is not already providing the necessary primary game, the gaming terminal downloads the resource data 26 from the secondary game system 2. This functionality is discussed in further detail in our copending PCT patent application published with the number WO 2006/096925 A1, the full contents of which are herein incorporated by reference.

In any of the previously described embodiments, screens may display information regarding the available secondary games, to enable users of the gaming terminals to make informed decisions as to which secondary game they wish to participate in. This information may include any or all of: the name of the secondary game, the presently accrued value of a jackpot, the maximum and minimum values of the jackpot, the number of gaming terminals presently registered in the secondary game, the primary games to which the secondary game is restricted (if any), and so on.

In some embodiments, screens 27 (in FIG. 2) are controlled by the secondary game controllers via a video card 21 (shown in FIG. 4). Additionally or alternatively, the information may be shown on screens 28 (in FIG. 2) connected to the secondary controllers via the same communications path as the gaming terminals. Additionally or alternatively, the display screen 8 or the touch screen 13 of the gaming terminals may display this information. Finally, the secondary game coordinator 23 may drive one or more displays for providing this information to users of the gaming terminals, or dedicated display units 29 may be connected to the Ethernet network (shown in FIG. 5). Thus, any or all of the above information may be communicated around the gaming network and stored in memory in various locations, including: memory 10 of the gaming terminals 5, memory in the communications card 11 of the gaming terminals, memory 17 of the secondary game controllers 3, and memory inner the database 24 maintained by—the secondary game coordinator 23.

In some embodiments of the invention, the gaming terminals are provided in a single venue. In alternative embodiments, the gaming terminals are distributed among a number of such establishments or other locations and/or the terminals include other devices such as personal computers. In some such latter cases, communication between the terminals and the secondary game system may be effected for example by means of an existing network, such as the internet, or by telephone dial-up or radio communication or by a combination of the above.

Although the invention has been described with reference to specific examples, it will be appreciated by those skilled in the art that it may be embodied in many other forms. In particular features of any one of the various described examples may be provided in any combination in any of the other described examples.

1-23. (canceled)

24. A secondary game system for a gaming terminal network, including:
at least one secondary game controller for providing at least one secondary game; and
a communications device for receiving secondary game registration request messages and secondary game deregistration request messages from a gaming terminal;
the system being responsive to a received secondary game registration request message from a gaming terminal by causing said gaming terminal to be registered in one of said at least one secondary game; and
the system being further responsive to a received secondary game deregistration request message from a gaming terminal by causing said gaming terminal to be deregistered from one of said at least one secondary game.

25. A secondary game system according to claim 24, including a plurality of secondary game controllers for providing respective secondary games.

26. A secondary game system according to claim 25, being responsive to a received secondary game registration request message from a gaming terminal by causing said gaming terminal to be registered in one of said secondary games selected in dependence upon data extracted from said secondary game registration request message.

27. A secondary game system according to claim 25, being responsive to a received secondary game deregistration request message from a gaming terminal by causing said gaming terminal to be deregistered from one of said secondary games determined in dependence upon data extracted from said secondary game deregistration request message.

28. A secondary game system according to claim 25, wherein the secondary game controllers include respective secondary game controller communications devices for receiving messages from respective pluralities of gaming terminals.

29. A secondary game system according to claim 28, wherein each of the secondary game controllers is adapted upon receipt of a secondary game registration request message or a secondary game deregistration request message to communicate with another of the secondary game controllers in dependence upon data extracted from said secondary game registration request message or secondary game deregistration request message.

30. A secondary game system according to claim 28, wherein the secondary game controller communications devices are adapted to receive secondary game contribution messages, and wherein the secondary game controllers are adapted upon receipt of a secondary game contribution message to communicate with another of the secondary game controllers.

31. A secondary game system according to claim 25, including a secondary game coordinator in communication with said plurality of secondary game controllers, and adapted to maintain a database including for each of a plurality of gaming terminals data indicative of respective secondary games in which the gaming terminal is registered.

32. A gaming system including a gaming terminal and a secondary game system according to claim 24.

33. A gaming system according to claim 32, wherein the gaming terminal includes a user-operable registration input device for allowing a user of the gaming terminal to indicate a desire to register in a secondary game, and wherein the gaming terminal is responsive to operation of the user-operable registration input device by sending a secondary game registration request message to the secondary game system.

34. A gaming system according to claim 32, wherein the gaming terminal includes a user-operable deregistration input device for allowing a user of the gaming terminal to indicate a desire to deregister from a secondary game, and wherein the gaming terminal is responsive to operation of the user-operable deregistration input device by sending a secondary game deregistration request message to the secondary game system.

35. A gaming system according to claim 32, wherein the gaming terminal includes a user-operable secondary game contribution input device for allowing a user of the gaming terminal to specify a desired contribution to a secondary game.

36. A method of providing at least one secondary game in a gaming terminal network, including:
receiving secondary game registration request messages and secondary game deregistration request messages from a gaming terminal;
responding to a received secondary game registration request message from a gaming terminal by causing said gaming terminal to be registered in one of said at least one secondary game; and
responding to a received secondary game deregistration request message from a gaming terminal by causing said gaming terminal to be deregistered from one of said at least one secondary game.

37. A method according to claim 36, including providing a plurality of secondary games.

38. A method according to claim 37, wherein the step of responding to a received secondary game registration request message from a gaming terminal includes the steps of:
extracting data from said secondary game registration request message; and
causing said gaming terminal to be registered in one of said secondary games selected in dependence upon said extracted data.

39. A method according to claim 37, wherein the step of responding to a received secondary game deregistration request message from a gaming terminal includes the steps of:
extracting data from said secondary game deregistration request message; and
causing said gaming terminal to be deregistered from one of said secondary games determined in dependence upon said extracted data.

40. A method according to claim 36, including the step of:
maintaining a database including for each of a plurality of gaming terminals data indicative of respective secondary games in which the gaming terminal is registered.

41. A method according to claim 36 wherein the steps are executed using a computer program.

42. A method according to claim 41 wherein the computer program is embodied in data carried on a data carrier.

43. A method according to claim 41 wherein the computer program is embodied in data carried in a signal.
